(19) United States
(12) Patent Application Publication
(10) Pub. No.: US 2008/0204630 A1
(43) Pub. Date: Aug. 28, 2008

(54) Backlight module having elastic structures at frame and liquid crystal display using same

(75) Inventors: Yu-Chih Hsieh, Miao-Li (TW); Ching-Tung Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/072,777

(22) Filed: Feb. 28, 2008

(30) Foreign Application Priority Data
Feb. 28, 2007 (CN) 200720118544.3

(51) Int. Cl. G02F 1/1335

(52) U.S. Cl. 349/62; 362/311

(57) ABSTRACT

An exemplary backlight module (42) includes a light guide plate (47) and a frame (46) for receiving the light guide plate. The frame includes a plurality of side walls (462) and a plurality of elastic structures (463). The elastic structures extend from top surfaces of the side walls.

### FIELD OF THE INVENTION

The present invention relates to a backlight module having elastic structures at frame and a liquid crystal display using the backlight module.

### GENERAL BLACKGROUND

Liquid crystal displays (LCDs) have the advantages of portability, low power consumption, and low radiation. Therefore, the LCDs have been widely used in common daily life. Typically, an LCD includes a backlight module. The backlight module provides uniform flat light to enable the LCD to display images.

FIG. 6 is an exploded, isometric view of a conventional liquid crystal display 10. The liquid crystal display 10 includes a liquid crystal display panel 11 and a backlight module 12. The liquid crystal display panel 11 includes a side edge 111. The backlight module 12 includes an upper prism sheet 13, a lower prism sheet 14, a diffusion sheet 15, a frame 16, a light guide plate 17, and a reflector 18. The upper prism sheet 13, the lower prism sheet 14, and the diffusion sheet 15 are disposed in that order from top to bottom.

Referring also to FIG. 7, this is a cross-sectional view of the frame 16 taken along line VII-VII of FIG. 6. The frame 16 includes four side walls 162 and a plurality of blocking plates 161. The four side walls 162 are joined end to end and cooperatively define a first space (not labeled) therebetween for receiving the upper prism sheet 13, the lower prism sheet 14, the diffusion sheet 15, the light guide plate 17, and the reflector 18. The blocking plates 161 are formed at outer portions (not labeled) of top surfaces (not labeled) of the side walls 162. The blocking plates 161 together with inner portions (not labeled) of the top surfaces of the side walls 162 cooperatively define a second space (not labeled) therebetween for receiving the liquid crystal display panel 11.

The liquid crystal display 10 is assembled by the following steps. Firstly, the light guide plate 17 and the reflector 18 are disposed in the first space from the bottom side of the frame 16, respectively. Secondly, the upper prism sheet 13, the lower prism sheet 14, and the diffusion sheet 15 are disposed in the first space from the upside of the frame 16, respectively. The diffusion sheet 15 is adjacent to the light guide plate 17. Thirdly, the side edge 111 of the liquid crystal display panel 11 is disposed at a corresponding top surface of the side walls 162. The liquid crystal display panel 11 is then revolved round the side edge 111 and downwards to contact the inner portions of the top surfaces of the side walls 162. Thereby, the liquid crystal display panel 11 is supported by the top surfaces of the frame 16 and is received in the second space, as shown in FIG. 8.

Generally, the liquid crystal display panel 11 is brittle, and the frame 16 is typically made of hard material. That is, in use of the liquid crystal display 10 or during the process of assembling the liquid crystal display 10, the liquid crystal display panel 11 is liable to subject to an impact force applied by the frame 16. The impact force may be applied to the liquid crystal display panel 11 in the thickness direction of the liquid crystal display 10. As a result, the liquid crystal display pane 11 is liable to be damaged by the impact force.

What is needed, therefore, is a backlight module and an associated liquid crystal display that can overcome the above-described deficiencies.

### SUMMARY

A backlight module includes a light guide plate and a frame for receiving the light guide plate. The frame includes a plurality of side walls and a plurality of elastic structures. The elastic structures extend from top surfaces of the side walls.

A liquid crystal display includes a liquid crystal display panel and a backlight module. The backlight module includes a frame. The frame includes a plurality of side walls and a plurality of elastic structures. The elastic structures extend from top surfaces of the side walls for supporting the liquid crystal display panel.

Other novel features and advantages will become more apparent from the following detailed description when taken in conjunction with the accompanying drawings.

### BRIEF DESCRIPTION OF THE DRAWINGS

FIG. 1 is an exploded, isometric view of a liquid crystal display according to a first embodiment of the present invention, the liquid crystal display including a frame.

FIG. 2 is a cross-sectional view of the frame taken along line II-II of FIG. 1.

FIG. 3 is an enlarged view of a circled portion III of FIG. 2.

FIG. 4 is an enlarged, cross-sectional view of part of a frame of a liquid crystal display according to a second embodiment of the present invention.

FIG. 5 is an isometric view of a frame of a liquid crystal display according to a third embodiment of the present invention.

FIG. 6 is an exploded, isometric view of a conventional liquid crystal display, the liquid crystal display including a frame.

FIG. 7 is a cross-sectional view of the frame taken along line VII-VII of FIG. 6.

FIG. 8 shows a process of assembling the liquid crystal display of FIG. 6.

### DETAILED DESCRIPTION OF PREFERRED EMBODIMENTS

Reference will now be made to the drawings to describe the preferred and exemplary embodiments in detail.

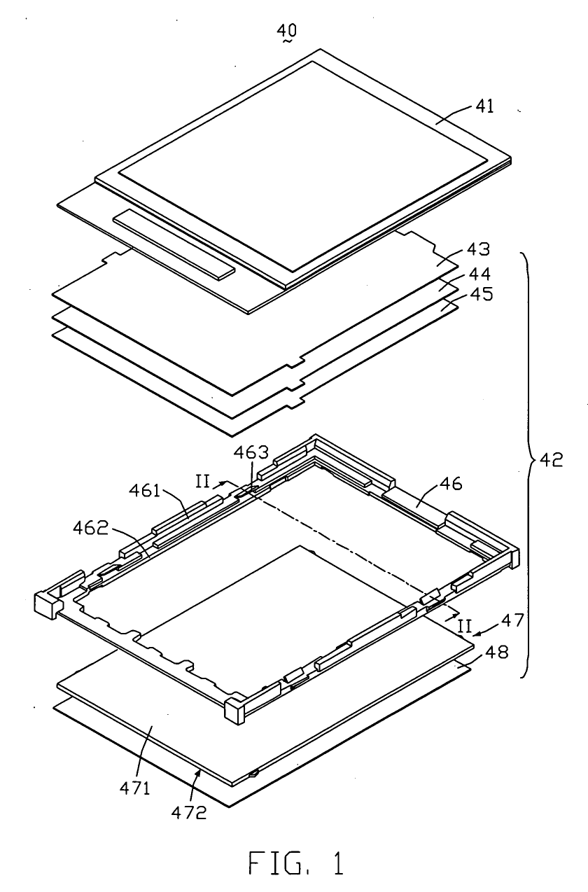

FIG. 1 is an exploded, isometric view of a liquid crystal display 40 according to a first embodiment of the present invention. The liquid crystal display 40 includes a liquid crystal display panel 41 and a backlight module 42 positioned opposite to the liquid crystal display panel 41. The backlight module 42 provides uniform flat light to illuminate the liquid crystal display panel 41.

The backlight module 42 includes an upper prism sheet 43, a lower prism sheet 44, and a diffusion sheet 45, a frame 46, a light guide plate 47, and a reflector 48. The upper prism sheet 43, the lower prism sheet 44, and the diffusion sheet 45 are disposed in that order from top to bottom. The frame 46 is made of metal, plastic or another suitable material.

The light guide plate 47 includes a light emission surface 471 and a bottom surface 472 opposite to the light emission surface 471. The reflector 48 is disposed adjacent to the bottom surface 472 of the light guide plate 47.

The frame 46 includes four side walls 462, a plurality of blocking plates 461, and a plurality of elastic plates 463. The elastic plates 463 and the side walls 462 are integrated into one body. The four side walls 462 are joined end to end and cooperatively define a first space (not labeled) for receiving the upper prism sheet 43, the lower prism sheet 44, the diffusion sheet 45, the light guide plate 47, and the reflector 48. The blocking plates 461 are formed at outer portions (not labeled) of top surfaces (not labeled) of the side walls 462. The blocking plates 461 together with inner portions (not labeled) of the top surfaces of the side walls 462 cooperatively define a second space (not labeled) for receiving the liquid crystal display panel 41.

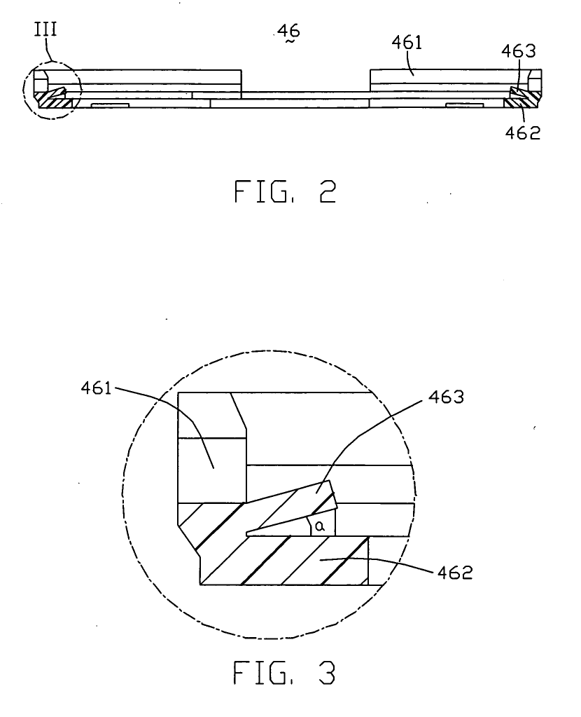

Referring also to FIGS. 2 and 3, FIG. 2 is a cross-sectional view of the frame 46 taken along line II-II of FIG. 1, and FIG. 3 is an enlarged view of a circled portion III of FIG. 2. In the present embodiment, the frame 46 includes four elastic plates 463 that symmetrically formed at inner portions (not labeled) of the top surfaces (not labeled) of two opposite side walls 462. Each of the elastic plates 463 is an oblique plate and intiltedly extends from a top surface of the side walls 462 towards the inner side of the frame 46. Each of the elastic plates 463 together with the corresponding top surface of the side walls 462 defines an acute angle a which can be varied in the range from 1 degree to 60 degrees.

The liquid crystal display 40 is assembled by the following steps. Firstly, the light guide plate 47 and the reflector 48 are disposed in the first space from the bottom side of the frame 46. The reflector 48 is disposed adjacent to the bottom surface 472 of the light guide plate 47. Secondly, the upper prism sheet 43, the lower prism sheet 44, and the diffusion sheet 45 are disposed in the first space from the upside of the frame 46. The diffusion sheet 45 is disposed adjacent to the light emission surface 471 of the light guide plate 47. Thirdly, one of the side edges (not labeled) of the liquid crystal display panel 41 is disposed at corresponding top surface of the side walls 462. The liquid crystal display panel 41 is revolved round the side edge and downwards to contact the elastic plates 463. Thereby, the liquid crystal display panel 41 is received in the second space of the frame 46.

The elastic plates 463 are located at the frame 46. When an impact force in the thickness direction of the liquid crystal display 40 is applied at the liquid crystal display panel 41, the elastic plates 463 are pressed towards the top surfaces of the side walls 462 gradually. That is, the elastic plates 463 have an elastic deformation for supporting the liquid crystal display panel 41. As a result, the impact force applied at the liquid crystal display panel 41 can be absorbed by the elastic plates 463. Therefore, in use of the liquid crystal display 40 or during the process of assembling the liquid crystal display panel 41, even if the liquid crystal display panel 41 may be subjected to a large impact force in the thickness direction of the liquid crystal display 40, the liquid crystal display panel 41 is not easily damaged.

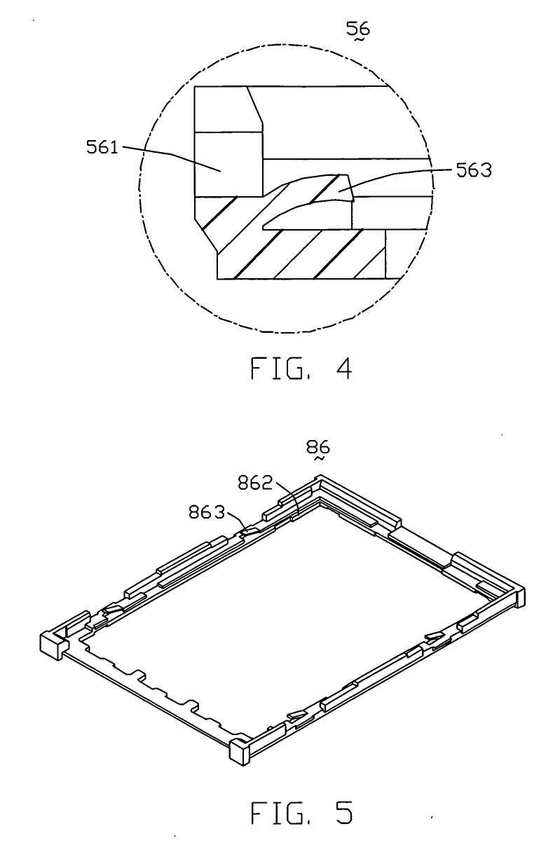

FIG. 4 is an enlarged, cross-sectional view of part of a frame 56 of a liquid crystal display (not labeled) according to a second embodiment of the present invention. The liquid crystal display has similar structures to that of the liquid crystal display 40. However, the frame 56 includes arc-shaped elastic plates 563 intiltedly extending from a top surface of a side wall towards inner side of the frame 56.

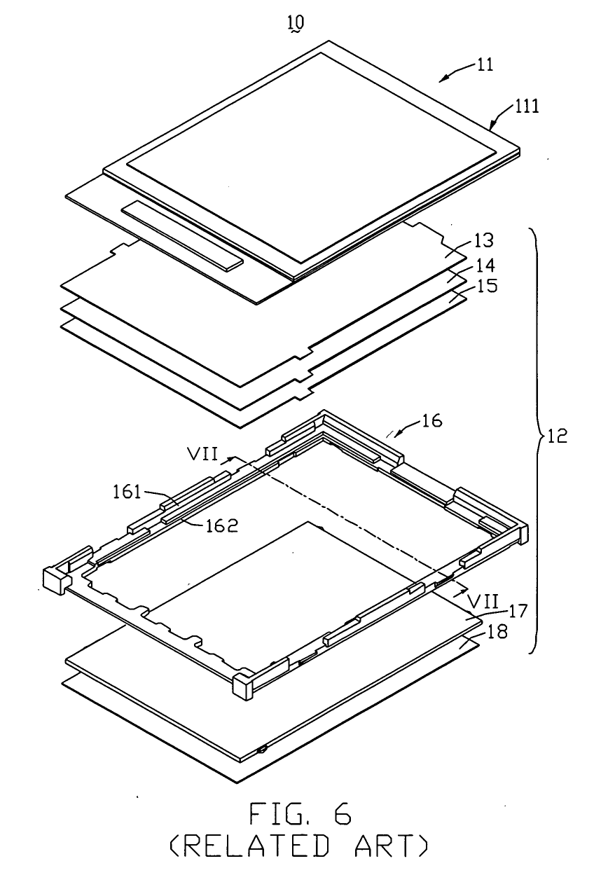

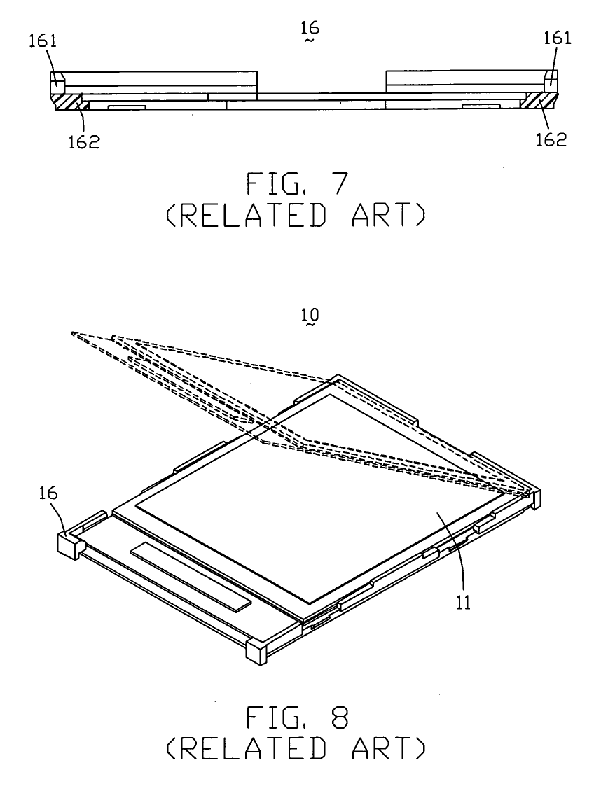

FIG. 5 is an isometric view of a frame 86 of a liquid crystal display (not labeled) according to a third embodiment of the present invention. The liquid crystal display has similar structures to that of the liquid crystal display 40. However, four elastic plates 863 are symmetrically located at two opposite side walls 862. Each of the elastic plates 863 slants upwards from a top surface of a side wall 862.

Various modifications and alterations to the above-described embodiments are possible. For example, each of the elastic plates 463 may be in the form of a separate body with the frame 46. In such case, each elastic plate can be fixed to the frame 46 by suitable means such as adhesion or interferential engagement.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module, comprising:
a light guide plate; and
a frame for receiving the light guide plate, the frame comprising:
a plurality of side walls; and
a plurality of elastic structures extending from top surfaces of the side walls.

2. The backlight module as claimed in claim 1, wherein the elastic structures are elastic plates.

3. The backlight module as claimed in claim 2, wherein the elastic plates are oblique elastic plates.

4. The backlight module as claimed in claim 3, wherein the elastic plates intiltedly extend towards inner side of the frame.

5. The backlight module as claimed in claim 3, wherein each of the elastic plates together with the corresponding top surface of the side walls cooperatively define an acute angle.

6. The backlight module as claimed in claim 5, wherein the acute angle varies in the range from 1 degree to 60 degrees.

7. The backlight module as claimed in claim 2, wherein the elastic plates and the side walls are integrated into one body.

8. The backlight module as claimed in claim 2, wherein each of the elastic plates is in the form of a separate body with the frame.

9. The backlight module as claimed in claim 2, wherein each of the elastic plates is an arc-shaped elastic plate.

10. The backlight module as claimed in claim 9, wherein each of the elastic plates intiltedly extends toward inner side of the frame.

11. The backlight module as claimed in claim 2, wherein the elastic plates are symmetrically located at two opposite side walls.

12. The backlight module as claimed in claim 2, wherein the elastic plates slant upwards from the top surfaces of the side walls.

13. The backlight module as claimed in claim 1, wherein the frame is made of plastic.

14. A liquid crystal display, comprising:
a liquid crystal display panel; and
a backlight module having a frame, the frame comprising:
a plurality of side walls; and
a plurality of elastic structures extending from top surfaces of the side walls for supporting the liquid crystal display panel.

15. The liquid crystal display as claimed in claim 14, wherein the elastic structures are elastic plates.

16. The liquid crystal display as claimed in claim 15, wherein the elastic plates are oblique elastic plates.

17. The liquid crystal display as claimed in claim 16, wherein each of the elastic plates together with the corresponding top surface of the side walls cooperatively define an acute angle varying in the range from 1 degree to 60 degrees.

18. The liquid crystal display as claimed in claim 14, wherein the elastic structures support the liquid crystal display panel in a thickness direction of the liquid crystal display.

19. The liquid crystal display as claimed in claim 14, wherein the backlight module further comprises a light guide plate, the side walls of the frame being joined end to end and cooperatively forming another space for receiving the light guide plate.

20. The backlight module as claimed in claim 14, wherein the elastic plates and the side walls are integrated into one body.
